(19) United States
(12) Patent Application Publication
(10) Pub. No.: US 2008/0084573 A1
(43) Pub. Date: Apr. 10, 2008

(54) SYSTEM AND METHOD FOR RELATING UNSTRUCTURED DATA IN PORTABLE DOCUMENT FORMAT TO EXTERNAL STRUCTURED DATA

(76) Inventors: Yoram HOROWITZ, Kazmiel (IL); Nir Arazi, Nahariya (IL)

Correspondence Address: SAP_DLG, 7910 IVANHOE AVE., # 325, LA JOLLA, CA, 92037, US

(21) Appl. No.: 11/548,274

(22) Filed: Oct. 10, 2006

(51) Int. Cl. G06F 3/12

(52) U.S. Cl. 358/1.13

(57) ABSTRACT

A system and method for relating unstructured data in portable document format to external structured data. A software component layered on top of an existing PDF document to bridge static information in the document to dynamic information in an external IT system. A PDF document may be parsed and “hotspotted” to provide clickable areas that allow for windows to show structured data without adding hyperlinks to the PDF document. Input information is used to provide descriptions of items of interest that are to be used as hotspots which are located in the document and optionally visually marked. The input information may be in the form of a general regular expression for example. Types of unstructured PDF files include manuals, brochures, etc. Types of structured data include material, business process, finance, or any other type of data including enterprise data. Dynamic data is thus obtained for a static PDF document. May also seamlessly mine PDF or other document files stored in a data repository without presentation to the user in the form of a view

### BACKGROUND OF THE INVENTION

1. Field of the Invention

Embodiments of the invention described herein pertain to the field of computer systems. More particularly, but not by way of limitation, one or more embodiments of the invention enable a system and method for relating unstructured data in a portable document format to external structured data, such as data in a database or back-end Information Technology (IT) application relying on a database (IT system).

2. Description of the Related Art

Portable document format are static in nature. Once created, there is no known way to relate information in the document to dynamic data in an IT system. For example, current systems lack a method for enabling users to accept a user click on a part number in a PDF to access sales information related to that part as accessed through an IT system.

Although it is possible to embed hyperlinks into PDF documents, once a PDF document or catalog is created without hyperlinks, information in the document is effectively isolated from external data sources. Creating a PDF document that uses hyperlinks to external data requires a document writer to know the specifics of external data sources such as URI, table names, field names that describe elements in the document for which external bridging is required. In addition, the document creator must create links everywhere in the document where data is located that there is a desire to show external information. Such functionality is generally beyond the capabilities of a user tasked with generation of a manual, portable document such as a product catalog or brochure.

PDF documents may be created with external data, for example through a Microsoft® Word® report template that inserts external data into a document that is converted to PDF. However, once the report is created from the external data, the resulting PDF document is static in that there is no link to current information in the external data source. The following template generates a table with static information that will not change unless the entire document is recreated. In this scenario, as soon as the document is created, it is obsolete as soon as external data changes.
/*Generate Product Catalog*/
@F1=Report(type=form cell=CatName, Descr, ProdName, ProdID, QtyPerUnit, UnitPrice range=Prod group=1,2 grouprange=Cat)
SELECT CatName, Descr, ProdName, ProdID, QtyPerUnit, UnitPrice
FROM Prods, Cats
WHERE Prods.CatID=Cats.CatID
ORDER BY 1,3;

For at least the limitations described above there is a need for a system and method for relating unstructured data in portable document format to external structured data.

### BRIEF SUMMARY OF THE INVENTION

One or more embodiments of the invention are directed to a system and method for relating unstructured data in portable document format to external structured data, such as data in a Information Technology (IT) system. Portable document format (PDF) files have become the de facto standard for document publishing. Embodiments of the invention utilize a software component that interfaces with an existing PDF document such as an invoice, catalog, manual or brochure to relate static unstructured information in the document to external structured data, for example dynamic information in an external database or back-end IT application relying on a database. Readers should note that although one or more embodiments of the invention are described in the context of a PDF document the concepts set forth herein are also applicable to other document formats or files where data is embedded with the file for purposes of defining the content and appearance of the document. Hence although the term PDF is used throughout the invention is not limited specifically to use of this data format as it also has applicability with other document formats and image data formats.

In one or more embodiments of the invention, information in a PDF document may be searched or parsed and “hotspotted” to provide areas that allow for popups or external windows to present structured data related to the unstructured data at the hotspot. Metadata input information is used to provide descriptions of items of interest that are to be used as hotspots which are located in the document. The hotspots are optionally marked to visually alert the reader of the document that a hotspot to external data exists. The metadata input information may be in the form of a general regular expression that describes the format of a part number for example. Metadata input information may also be obtained through a wizard or menu based interface to allow a user to select patterns that provide information related to pattern matches. Types of structured data include material, business process, finance, or any other type of data including any other form of enterprise data for example.

When a PDF document is presented to a user, embodiments of the system accept user input such as a mouse click that is processed to determine the hotspot that the mouse click occurred in. The hotspot where the mouse click occurs provides information that allows the system to relate to the proper structured data in an external IT system. By adding functionality to relate to external systems where no hyperlinks occur in an existing document, dynamic data is thus obtained for a static document that itself has no external links to information.

For example, an assembly guide with exploded product drawings may bridge to information in an external bill of materials. In another scenario, a marketing brochure may bridge to a customer relationship management IT system to obtain related customer names, addresses and prices for items that appear in the marketing brochure. In yet another scenario a product catalog may bridge to sales information contained in a financial IT system.

### BRIEF DESCRIPTION OF THE DRAWINGS

The above and other aspects, features and advantages of the invention will be more apparent from the following more particular description thereof, presented in conjunction with the following drawings wherein:

FIG. 1 is an architectural view of an embodiment of the invention.

FIG. 2 is a view of a PDF file of an exemplary catalog in the form of a viewable PDF document.

FIG. 3 is a view of a structured data source in the form of a product sales table that is related to a part number found in the exemplary catalog of FIG. 2.

FIG. 3A is another embodiment of a view of a structured data source in the form of a table that is related to a part number found in the exemplary catalog of FIG. 2.

FIG. 4 is a view of a metadata file having at least one regular expression that defines a pattern match for part numbers corresponding to the part numbers shown in FIG. 2.

FIG. 5 is a view showing both the exemplary catalog of FIG. 2 with the product sales table shown in FIG. 3 that results when a user gesture such as a mouse click is accepted by the system over a hotspot corresponding to a pattern match found in the metadata file of FIG. 4.

FIG. 6 is a flowchart that illustrates the generation of hotspots for a PDF document using metadata input.

FIG. 7 is a flowchart that illustrates accepting layout type, external data identifiers, pivot information, style information and the storing of this accepted data to provide layouts for external data as shown in FIG. 3.

FIG. 8 is a flowchart that illustrates the access and presentation of external structured data corresponding to a hotspot.

### DETAILED DESCRIPTION

A system and method for relating unstructured data in portable document format to external structured data, such as data in an IT system will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

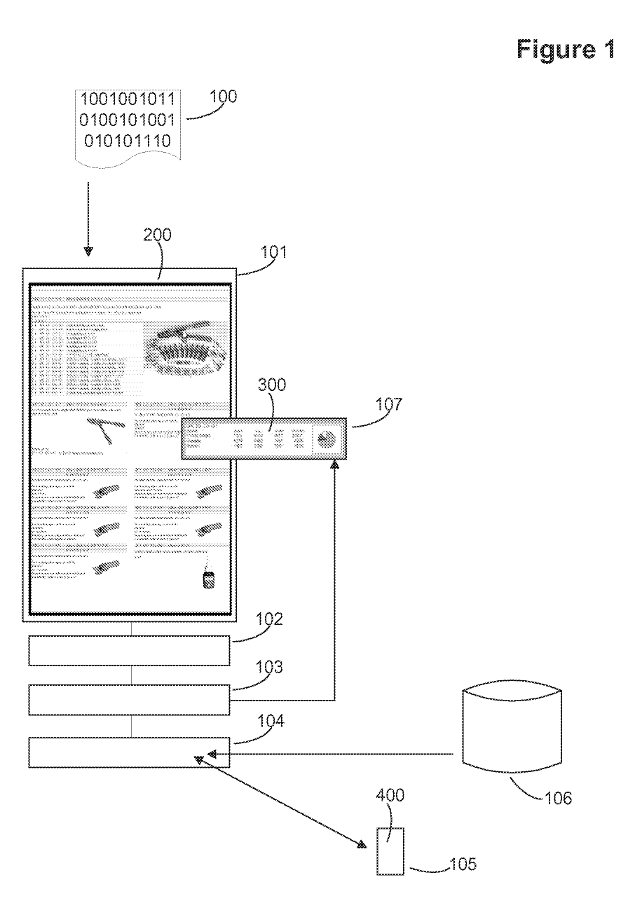

FIG. 1 is an architectural view of an embodiment of the invention. Portable document format (PDF) files such as PDF file 100 have become the de facto standard for document publishing. PDF file 100 is a binary file that is not human readable. When viewed in PDF viewer 101, PDF file 100 is displayed as PDF document 200 that is in human readable form. PDF document 200 may contain text and graphics in a rich variety of styles. PDF viewer API 102 allows for interfacing to a given PDF viewer such as PDF viewer 101. Embodiments of the invention utilize software component 103 to interface to PDF document 200 via PDF viewer API 102. PDF document may be an invoice, catalog, manual or brochure or any other document for example. External communication component 104 obtains data from external data source 106 and in addition is utilized to obtain and store metadata input information 400 in external metadata repository 105. Metadata input information describes patterns that signify matches for data in PDF document 200 that may be bridged to external data. Metadata input information 400 may relate to one or more PDF documents. Metadata input information 400 enables the generation of “hotspots” that allow areas in PDF document 200 to bridge to external data. Hotspots are not required to be stored in PDF document 200 as hyperlinks are. External metadata repository 105 may for example be implemented with a database. An action occurs when a user gesture is accepted by the system, for example when the user clicks on a hotspot corresponding to a metadata input information pattern, for example a part number or picture that internal to the PDF file contains a part number. For example, external data 300 is presented in user interface component 107 when a hotspot is asserted with a user gesture.

A hotspot bridges static unstructured information in PDF document 200 to external structured data 300, for example dynamic information in external data source 106 without use of links in PDF document 200. Types of structured data in external data source 106 may include material, business process, finance, or any other type of data including any other form of enterprise data for example. Enabling a PDF document to bridge to external data without hyperlinking to an external data source allows document creators to do what they do best, which is to create style rich PDF documents. This non-hyperlinking methodology allows data-aware personnel to bridge information in the PDF documents to external data sources. Software component 103 may independently display external structured data 300 in user interface component 107, or may request integrated display of external structured data 300 in PDF viewer 101 for example as a balloon or comment block via PDF viewer API 102.

In accordance with one or more embodiments of the invention external communication component 104 is configured to seamlessly mine PDF or other document files stored in a data repository without presentation to the user in the form of a view. When mining data in this manner the external communication components are associated with external data source 106 using metadata or other information stored in external metadata repository for establishing the association. Obtaining data from a PDF or other document type via a seamless data mining operation provides systems incorporating such functionality with a method for automating the hotspot generation process without requiring the visual display of the document itself. Systems may for instance, accept a metadata pattern, search at least one document in the repository for the pattern and use that information to generate and store hotspot information associated with the document. When handled in this general manner display of the document is optional and not required in order to facilitate a relation between the document and the repository.

In one or more embodiments of the invention, metadata input information 400 is generated independently of PDF file 100 creation. In addition, external structured data 300 may be formatted or have styles applied to control the layout of the information displayed in user interface component 107. The formatting used for presenting external structured data 300 is generated independently of PDF file 100 creation. Hotspots in PDF document 200 may optionally be marked to visually alert the reader of the document that a hotspot to external data exists. The hotspot may or may not appear like a hyperlink, however hotspots may be stored separately from PDF document 200. Metadata input information may also be obtained through a wizard or menu based interface to allow a user to select patterns that provide information related to pattern matches.

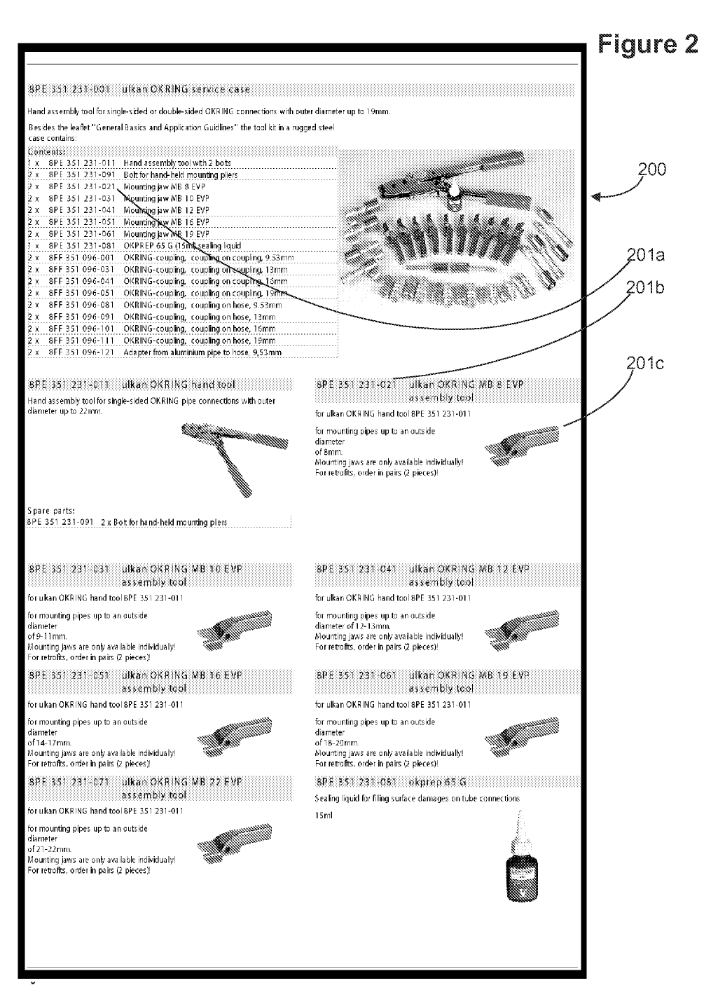

FIG. 2 is a view of a PDF file of an exemplary catalog in the form of a viewable PDF document 200. Unstructured data 201a may include a part number, a portion of a part number a product name or any other piece of information that may be used to identify unstructured data 201a. Unstructured data 201b may include a picture with text that is scanned to determine if a part number for example exists in the graphic. Unstructured data 201c may include an image name that allows for identification of the unstructured data, again here a part number in this example. Although many different forms of data and references correlate to a given piece of unstructured data, in this case all three examples correlate to the same piece of unstructured data, e.g. a part number.

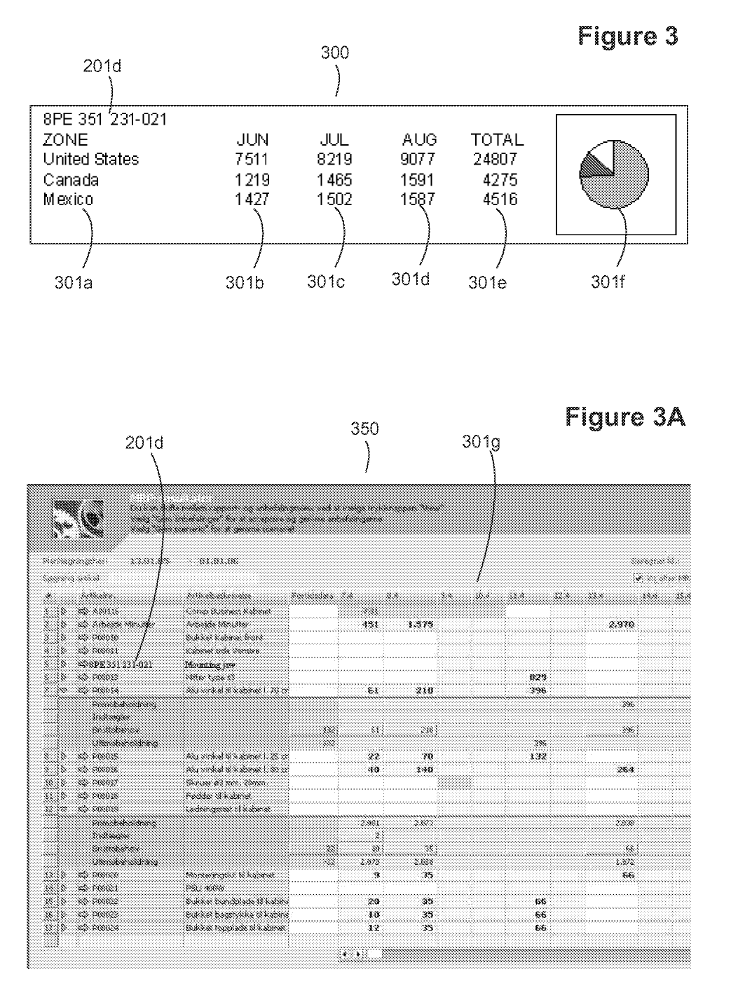

FIG. 3 is a view of external structured data 300 in the form of a product sales table that is related to unstructured data that exists in and which is not hyperlinked from PDF document, e.g., the catalog of FIG. 2. The common link in this example is a pattern that matches unstructured data 201d in a particular format and which allows for obtaining desired data from external data source 106. For example, if a user clicks on a hotspot in PDF document 200 that corresponds to unstructured data 201a-d, then external structured data 300 which corresponds to unstructured data 201a-d may be displayed in user interface component 107. As will be detailed later, the desired information to be displayed as external structured data 300 may be selected and formatted by accepting user input related to direct the quantity, format and types of information displayed. Optionally, a list of different views may be presented to the user which allows for multiple types of external structured data or formats for the external structured data to be displayed. For example, a list including a sales information view and a manufacturer availability view may be presented. In this case, if the user selects a sales information view, then the external structured data 300 includes sales information. If the user selects a manufacturer availability view, then lead times and schedules may be displayed. This allows for multiple types of independent information from possibly entirely different external data sources to be presented based on one hotspot associated with PDF document 200. For the unstructured data shown in PDF document 200, namely unstructured data 201d corresponding to a part number of “8PE_{—}351_{—}231-021” where an underscore “_” is used to show white space, external structured data obtained for example from an external IT system using “8PE_{—}351_{—}231-021” as part of a query is shown in FIG. 3. Zone 301a shows the area for which the row of information is related, time periods 301b, 301c and 301d show sales figures for the months of June, July and August. Total sales figures 301e are shown in the rightmost text column and are a row by row summary of the sales information over the time periods 301b-d per zone 301a. Pie chart 301f shows percentage of total sales per zone. Optionally, a graphic may include a key showing the colors or row numbers that each portion of the graphic corresponds to. In embodiments that present a list of views, then an entirely different view or a view that has the same information formatted in a different say may be displayed in user interface component 107. For example an alternate or additional view of external structured data is shown in FIG. 3A. The common link in this example is a pattern that matches unstructured data 201d in a particular format and which allows for obtaining desired data from external data source 106. For example, if a user clicks on a hotspot in PDF document 200 that corresponds to unstructured data 201a-d, then external structured data 350 which corresponds to unstructured data 201a-d may be displayed in user interface component 107. For the unstructured data shown in PDF document 200, namely unstructured data 201d corresponding to a part number of “8PE_{—}351_{—}231-021”, external structured data obtained for example from an external IT system using “8PE_{—}351_{—}231-021” as part of a query is shown in FIG. 3A. Table 301g shows any information related to unstructured data 201d. The table may show information for only the product asserted in the unstructured data, i.e., 201d, or for other products related to unstructured data 201d. Any type of information may be shown in table 301g including but not limited to monetary, time, location, supplier, manufacture, product, family or any other type of information. Table 301g may include views that are one, two or multi-dimensional in nature including graphs, charts, pictures, or any other type of data.

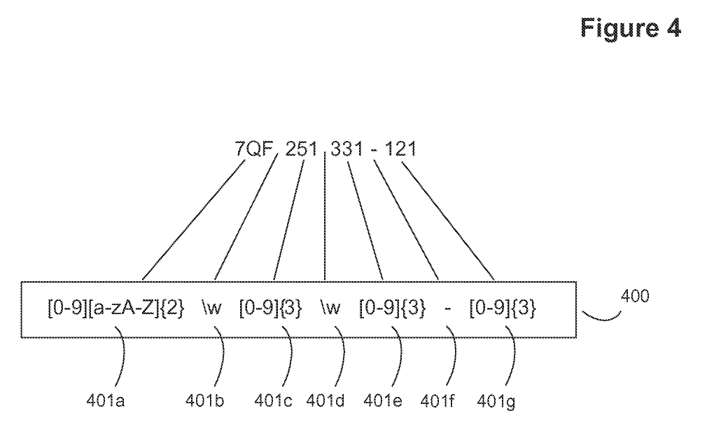

FIG. 4 is a view of a metadata file having at least one regular expression that defines a pattern match for unstructured data in PDF document 200, which in this example are part numbers corresponding to the part numbers shown in FIG. 2. In this figure, metadata input information 400 is stored as a regular expression, however this is not required. Any method of generating a pattern that may match unstructured data is in keeping with the spirit of the invention. For example, a wizard or other user interface type may present options and accept inputs for the matching of letters, characters, numbers, symbols or any other type of text. In this example, the pattern “7QF_{—}251_{—}331-121” matches the pattern shown where underscores “_” show white space. “7QF” matches “[0-9][a-zA-Z]{2}” since the first character “7” matches the pattern [0-9], the second character “Q” matches the pattern [a-zA-Z] and the third character “F” matches “[a-zA-Z]” since the second pattern [a-zA-Z] is repeated twice via the repeat operator “{2}”. The remaining portion of the pattern matches since “\w” matches white space and a “−” character matches the portion of the pattern between “331” and “121”. The metadata input information may be stored as a file or as part of a database depending on the implementation utilized for metadata repository 105.

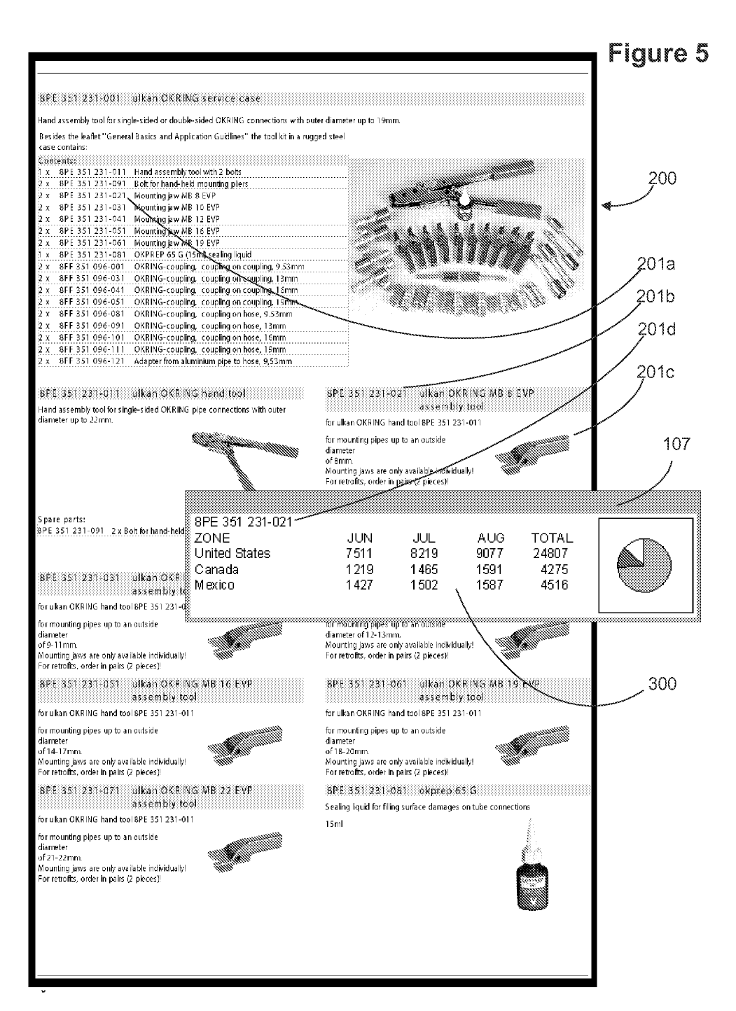

FIG. 5 is a view showing both the exemplary catalog of FIG. 2 with the product sales table shown in FIG. 3 that results when a user gesture such as a mouse click is accepted by the system over a hotspot corresponding to a pattern match found in the metadata file of FIG. 4. User interface component 107 may be an external window displayed by software component 103, or may be displayed as a balloon or comment block in the PDF directly via PDF viewer API 102. Specifically, any hotspot corresponding to unstructured data 201a, 201b or 201c yields a presentation of corresponding external structured data 300 related to unstructured data 201a-c which is shown as unstructured data 201d, e.g., a part number associated with the hotspots. In one or more embodiments of the invention, the data may be live and may update as user interface component 107 is presented in either event driven real-time or on a polled basis. This allows for dynamic updates to external data source 106 to be viewed dynamically in association with static PDF document 200.

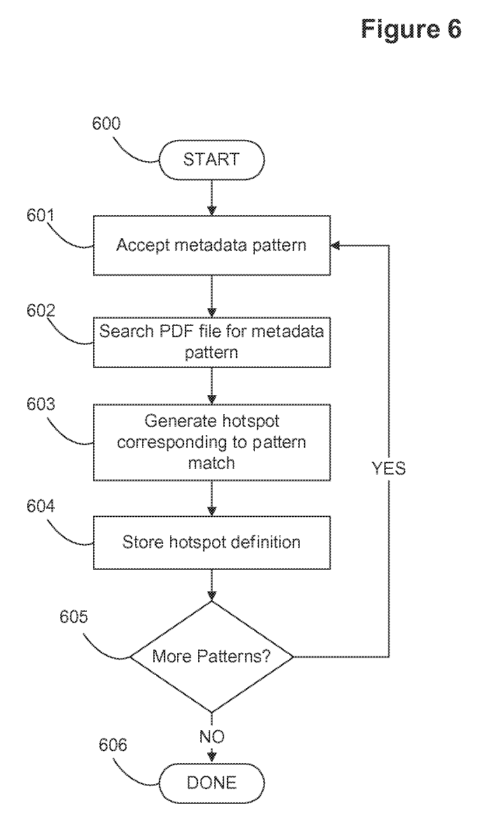

FIG. 6 is a flowchart that illustrates the generation of hotspots for a PDF document using metadata input. Processing starts at 600, the system accepts metadata input information or patterns at 601. This may involve use of text editor to create general regular expressions by hand, or by use of a graphical user interface component or wizard for building patterns. PDF file 200 is searched or scanned for occurrences of the metadata input information 400 at 602. For mining embodiments, a repository containing PDF or other files is automatically searched to generate hotspots without any visual display of the corresponding PDF document. This may involve searching PDF or scanning graphics or parsing image names within the PDF or referenced by the PDF to determine if a pattern match occurs. PDF files may be seamlessly mined with or without graphically displaying the files in one or more automated embodiments of the invention. If the pattern is found, then other portions of the PDF may be scanned to determine the location and size of the text, graphic or image for which a hotspot is to be generated. One skilled in the art of PDF format will recognize that the any method of obtaining locations and sizes of text, graphics or images is in keeping with the spirit of the invention. The hotspot is generated at 603 corresponding to the match at 603 and stored at 604. The hotspot may be stored in metadata repository 105 or in any other location. PDF file 100 is not required to be altered to add any hotspot related information. Optionally, the type of user interface element if any to be used for the hotspot may be specified. The hotspot may utilize an underline, may utilize negative colors or utilize any other method of graphically alerting a user that a hotspot exists in a given area. If there are more patterns to utilize as per decision branch 605, processing branches to 601, else processing completes at 606. For mining embodiments, at least one other iteration may be performed depending on the number of PDF files that a given repository stores.

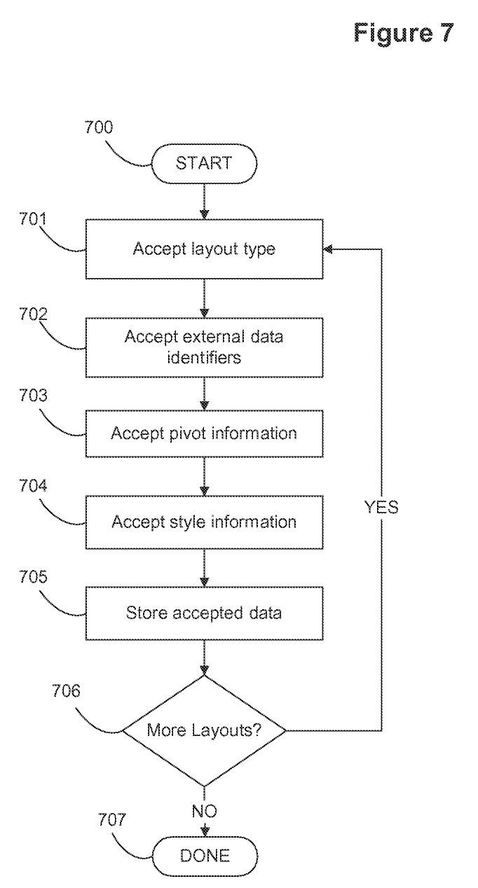

FIG. 7 is a flowchart that illustrates accepting layout type, external data identifiers, pivot information, style information and the storing of this accepted data to provide layouts for external data as shown in FIG. 3. Processing starts at 700 and the system accepts a layout type at 701. The layout type may include external window type, balloon type or comment type or any other type of viewer configured to view external structured data 300 related to a hotspot. The layout type may also specify tabular, graphical or any other type of view or combination of views that are to be utilized to view external structured data 300. The specific data identifiers to utilize in user interface component 107 is accepted at 702. This may involve accepting URI, port, or other address information along with table, field or attribute names for example. For tabular display of external structured data, at least one pivot type is optionally accepted at 703. This allows for consolidation of tabular data into a dense format that minimizes the amount of time required by a user to comprehend the information and minimizes the amount of graphical user interface area taken up by the information. Style information is accepted at 704 and may include fonts, sizes, colors or other information related to the style and not the content of the information to be displayed. The data that has been accepted is stored at 705 and may be stored in metadata repository 105 or in any other location. If there are more layouts to accept then processing continues at 701, otherwise processing completes at 707.

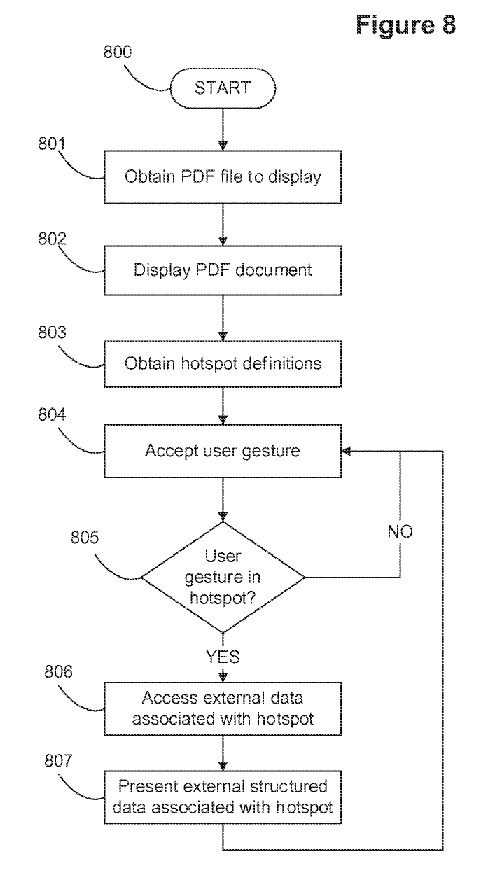

FIG. 8 is a flowchart that illustrates the access and presentation of external structured data corresponding to a hotspot. Processing starts at 800 and the system obtains a PDF file to display at 801. The PDF file is displayed as a PDF document at 802. Hotspot definitions are obtained at 803 (see FIG. 6). The system accepts user gestures, for example a mouse click, at 804 via PDF viewer API 102. If the user gesture does not occur over a hotspot, then processing continues to 804 until another user gesture is encountered. If the user gesture does occur over a hotspot at per decision point 805, then external information i.e., external data related to the hotspot is obtained from external data source 106. The external data is then presented by the system in user interface component 107 to the user at 807. Processing continues at 804 where another user gesture is awaited. The presentation of external data utilizes the layout information accepted by the system (see FIG. 7). In one or more embodiments of the invention, external structured data may change dynamically and be presented to the user in user interface 107 when the external structured data changes in event driven real-time mode, or on a polled basis.

While the invention herein disclosed has been described by means of specific embodiments and applications thereof, numerous modifications and variations could be made thereto by those skilled in the art without departing from the scope of the invention set forth in the claims.

What is claimed is:

1. A computer program product comprising computer readable instruction code executing in a tangible memory medium of a computer, said computer readable instruction code configured to:
accept metadata input information that describes a pattern to match associated with a PDF file;
search said PDF file for said pattern;
generate a hotspot corresponding to said pattern in said PDF file; and,
store hotspot information comprising said hotspot wherein said hotspot is not stored as a hyperlink in said PDF file.

2. The computer program product of claim 1 wherein said computer readable instruction code is further configured to:
accept a layout type;
accept an external data identifier;
accept style information; and,
stored said layout type, said external data identifier and said style information.

3. The computer program product of claim 1 wherein said computer readable instruction code is further configured to:
scan image data in said PDF file to find text in said image that matches said pattern.

4. The computer program product of claim 1 wherein said computer readable instruction code is further configured to:
obtain said PDF file to display;
display a PDF document as a visual instance of said PDF file;
obtain said hotspot information;
accept a user gesture;
access external information associated with said hotspot information; and,
present external structured data in a user interface component wherein said external structured data is associated with said hotspot information and said metadata input information.

5. The computer program product of claim 4 wherein said computer readable instruction code is further configured to:
present a list of views comprising a plurality of views associated with a single hotspot.

6. The computer program product of claim 4 wherein said computer readable instruction code is further configured to:
present a list of views comprising a plurality of views associated with a single hotspot;
accept input choice of a first view selected from said plurality of views; and,
present said external structured data using a set of graphical user interface components that differs from said first view and a second view selected from said plurality of views.

7. The computer program product of claim 4 wherein said computer readable instruction code is further configured to:
dynamically update said user interface component when said external structured data changes.

8. A computer program product comprising computer readable instruction code executing in a tangible memory medium of a computer, said computer readable instruction code configured to:
obtain a PDF file to display;
accept a metadata pattern;
search at least one PDF file in a repository for said metadata pattern;
generate at least one hotspot associated with said PDF file; and,
store hotspot information associated with said PDF file.

9. The computer program product of claim 8 wherein said computer readable instruction code is further configured to:
display a PDF document as a visual instance of said PDF file;
accept a user gesture;
obtain hotspot information;
accept a user gesture;
access external information associated with said hotspot information; and,
present external structured data in a user interface component wherein said external structured data is associated with said hotspot information and metadata input information; and,

10. The computer program product of claim 8 wherein said computer readable instruction code is further configured to:
present a list of views comprising a plurality of views associated with a single hotspot.

11. The computer program product of claim 8 wherein said computer readable instruction code is further configured to:
present a list of views comprising a plurality of views associated with a single hotspot;
accept input choice of a first view selected from said plurality of views; and,
present said external structured data using a set of graphical user interface components that differs from said first view and a second view selected from said plurality of views.

12. The computer program product of claim 8 wherein said computer readable instruction code is further configured to:
dynamically update said user interface component when said external structured data changes.

13. The computer program product of claim 8 wherein said computer readable instruction code is further configured to:
accept a layout type;
accept an external data identifier;
accept style information; and,
stored said layout type, said external data identifier and said style information.

14. The computer program product of claim 8 wherein said computer readable instruction code is further configured to:
accept said metadata input information that describes a pattern to match associated with said PDF file;
search said PDF file for said pattern;
generate a hotspot corresponding to said pattern in said PDF file; and,
store said hotspot information comprising said hotspot wherein said hotspot is not stored as a hyperlink in said PDF file.

15. The computer program product of claim 14 wherein said computer readable instruction code is further configured to:
scan image data in said PDF file to find text in said image that matches said pattern.

16. A computer program product comprising computer readable instruction code executing in a tangible memory medium of a computer, said computer readable instruction code configured to:
accept metadata input information that describes a pattern to match associated with a PDF file;
search said PDF file for said pattern;
generate a hotspot corresponding to said pattern in said PDF file;
store hotspot information comprising said hotspot wherein said hotspot is not stored as a hyperlink in said PDF file;
obtain said PDF file to display;
display a PDF document as a visual instance of said PDF file;
obtain said hotspot information;
accept a user gesture;
access external information associated with said hotspot information; and,
present external structured data in a user interface component wherein said external structured data is associated with said hotspot information and said metadata input information.

17. The computer program product of claim 16 wherein said computer readable instruction code is further configured to:
accept a layout type;
accept an external data identifier;
accept style information; and,
stored said layout type, said external data identifier and said style information.

18. The computer program product of claim 16 wherein said computer readable instruction code is further configured to:
scan image data in said PDF file to find text in said image that matches said pattern.

19. The computer program product of claim 16 wherein said computer readable instruction code is further configured to:
present a list of views comprising a plurality of views associated with a single hotspot.

20. The computer program product of claim 16 wherein said computer readable instruction code is further configured to:
present a list of views comprising a plurality of views associated with a single hotspot;
accept input choice of a first view selected from said plurality of views; and,
present said external structured data using a set of graphical user interface components that differs from said first view and a second view selected from said plurality of views.

21. The computer program product of claim 16 wherein said computer readable instruction code is further configured to:
dynamically update said user interface component when said external structured data changes.
